(19) United States
(12) Patent Application Publication
(10) Pub. No.: US 2014/0270073 A1
(43) Pub. Date: Sep. 18, 2014

(54) Method and System for Acquiring an X-Ray Image

(71) Applicant: Martin Spahn, Erlangen (DE)

(72) Inventor: Martin Spahn, Erlangen (DE)

(21) Appl. No.: 14/204,036

(22) Filed: Mar. 11, 2014

(30) Foreign Application Priority Data
Mar. 12, 2013 (DE) DE 102013204264.7

(51) Int. Cl. G01N 23/04

(52) U.S. Cl. CPC G01N 23/04
USPC 378/62

(57) ABSTRACT

A method acquires an X-ray image via a counting digital X-ray detector of an X-ray system. The X-ray detector has an X-ray converter for converting X-ray radiation into an electrical signal and a matrix having a plurality of counting pixel elements. At least one variable threshold value is applied for each pixel element such that an incoming signal is counted by a memory unit in each instance that the incoming signal exceeds the threshold value. The method includes receiving a request to acquire one or more X-ray images, automatically determining one or more threshold values individually adjusted to the X-ray image(s), setting the threshold values in the X-ray detector, applying X-ray radiation while the threshold values are applied, converting X-ray quanta into count signals, storing the count signals in the X-ray detector, outputting image data representing the X-ray image from the X-ray detector, and displaying or storing the X-image.

This application claims the benefit of DE 102013204264.7, filed on Mar. 12, 2013, which is hereby incorporated by reference in its entirety.

### BACKGROUND

The disclosed embodiments relate to a method and a device for acquiring an X-ray image of an examination subject using a counting digital X-ray detector.

X-ray systems are used for imaging in diagnostic examination and interventional procedures (e.g., in cardiology, radiology and surgery). As shown in FIG. 1, x-ray systems 16 include an X-ray tube 18 and an X-ray detector 17, both mounted, for example, on a C-arm 19. X-ray systems further include a high-voltage generator for producing the tube voltage, an imaging system 21 (often including at least one monitor 22), a system control unit 20 and a patient table 23. Systems having two levels (two C-arms) are also used in interventional radiology. Flat panel detectors are used as X-ray detectors in many fields of medical X-ray diagnostics and intervention, such as radiography, interventional radiology, cardioangiography, but also in therapy for imaging in the context of medical check-ups and treatment planning in, e.g., mammography.

Flat panel X-ray detectors are integrating detectors based predominantly on scintillators, the light from which is converted into electric charge in photodiode matrices. The photodiode matrices are then read out row-by-row via active control elements. FIG. 2 shows the basic layout of an indirectly converting flat panel X-ray detector that includes a scintillator 10, an active readout matrix 11 of amorphous silicon having a plurality of pixel elements 12 (with photodiode 13 and switching element 14) and drive and readout electronics 15 (see, e.g., M. Spahn, “Flat detectors and their clinical applications”, Eur Radiol. (2005), 15: 1934-1947). Depending on radiation quality, the quantum efficiency for a CsI scintillator having a layer thickness of, e.g., 600 mm, is between about 50% and 80% depending on radiation quality (see, e.g., M. Spahn, “Flat detectors and their clinical applications”, Eur Radiol. (2005), 15: 1934-1947). The spatial-frequency-dependent DQE(f) (“detective quantum efficiency”) is thereby limited in the upward direction and is much lower for typical pixel sizes of, e.g., 150 to 200 mm and for the spatial frequencies of 1 to 21 p/mm of interest for present applications. In order to support new applications (e.g., dual energy and material separation), and to increase the quantum efficiency still further, counting detectors are utilized, such as energy discriminating counting detectors based on directly converting materials (e.g., CdTe, CdZTe, or CZT) and contacted application specific integrated circuits (ASICs) (e.g. implemented in CMOS technology).

FIG. 3 shows a typical design of counting X-ray detectors. X-ray radiation is converted in the direct converter 24 (e.g., CdTe or CZT) and the generated charge carrier pairs are separated via an electric field. The electric field is generated by a shared top electrode 26 and a pixel electrode 25. In one of the pixel-shaped pixel electrodes 26 of the ASIC 27, the charge generates a charge pulse, the size of which corresponds to the energy of the X-ray quantum and which, if above a defined threshold value, is registered as a count event. The threshold value is used to distinguish an actual event from electronic noise or, for example, also to suppress k-fluorescence photons in order to avoid multiple counts. The ASIC 27, a corresponding section of the direct converter 24 and a coupling between direct converter 24 and ASIC 27 (in the case of directly-converting detectors e.g. by means of bump bonds 36) constitute the detector module 35. The detector module 35 has a large number of pixel elements 12. The ASIC 27 is disposed on a substrate 37 and connected to peripheral electronic devices 38. A detector module may also have one or more ASICs and one or more parts of a direct converter, selected as warranted in each case.

FIG. 5 shows the general diagram of a counting pixel element 12. The electric charge is collected via the charge input 28 in the pixel element, where the charge is amplified using a charge amplifier 29 and a feedback capacitor 40. The pulse shape may also be adjusted at the output in a shaper (filter) (not shown). An event is then counted by incrementing a digital memory unit (counter) 33 by one if the output signal is above a settable threshold value. Whether the output signal is above the threshold value is detected via a discriminator 31. In principle, the threshold value may also be predefined in a strictly analog manner, or applied via a digital-to-analog converter DAC 32 and therefore varied with a certain range. The threshold value may either be adjusted locally pixel by pixel, via the (local) discriminator 31 and the (local) DAC 32 as shown, or also globally for several (e.g., all) pixel elements via, for example, a global discriminator and DAC. Readout may then take place via a control and readout unit or peripheral electronics 38.

In one example, the threshold values may be controlled by the DACs, e.g., with a resolution of six bits. If the step size is then, e.g., 2 keV per bit, 128 keV may therefore be covered—assuming a linear response. Such coverage is sufficient for the majority of applications in angiography, cardioangiography, surgery or radiography. For a higher resolution, e.g., 1 keV/bit, at least one additional bit is used. Alternatively, an offset (e.g., at around 20 keV) may be coarsely defined. Above the offset, a DAC having a higher resolution of e.g. 1.5 keV/bit may be used.

It is sufficient to cover a keV range of about 20 to 80 keV if no threshold value is set close to the maximum energy to be expected as a result of the maximum tube voltage (e.g., 120 keV), so that a resolution of approximately 1.0 keV/bit may be achieved using 6 bits.

However, another pixel-wise calibration designed to correct pixel-to-pixel variations (e.g., variations of amplifiers 29, local material inhomogeneities of the detector material, etc.) may be warranted in addition to an application DAC used, e.g., to set a keV threshold for a whole detector module or rather the entire X-ray detector. This pixel-by-pixel calibration or correction DAC has a significantly higher resolution than the application DAC, e.g., 0.5 keV per bit, and may be adjusted, for instance, over a keV range within which the pixel-to-pixel variations are expected, e.g., 6 keV. In one example, 12 levels, or 4 bits, are sufficient. On the other hand, if the calibration or correction accuracy is, e.g., 0.1 keV per bit, 60 levels, or 6 bits, are used. If a calibration or correction DAC of this kind is provided, the application DAC and correction DAC are implemented separately. The application DAC may be designed as a global DAC having somewhat lower resolution (e.g., 2 keV/bit). The global DAC generates a voltage applied to each pixel element of the detector module or all of the detector modules of a detector and on which a pixel-by-pixel correction voltage is superimposed pixel-by-pixel via a higher resolution correction DAC (e.g., 0.1 keV/bit). If a plurality of threshold values and counters are provided for each pixel element (spectral imaging), a plurality of global application DACs are used and a calibration or correction DAC may be provided for each discriminator if, for example, the circuit behaves in a nonlinear manner. However, the following description does not relate to the calibration or correction DACs.

FIG. 6 schematically illustrates a complete array of counting pixel elements 12, e.g., 100×100 pixel elements, each measuring, e.g., 180 mm. In this example, the array has a size of 1.8×1.8 cm². For large-area detectors (e.g., 20×30 cm²), a plurality of detector modules 35 are combined (in this example, an 11×17 array produces roughly this area) and connected by the shared peripheral electronic devices. Through silicon via (TSV) technology, for example, is used for the connection between ASIC and peripheral electronics in order to ensure maximally tight side-by-side mountability of the modules on four sides.

In the case of counting and energy-discriminating X-ray detectors, two, three (as shown in FIG. 7) or more different threshold values are introduced. The height of the charge pulse classified according to the predefined threshold values (discriminator thresholds) is integrated into one or more of the digital memory units (counters). The X-ray quanta counted in a given energy field may then be obtained by calculating the difference between the counter contents of two corresponding counters. The discriminators may be adjusted, e.g., using digital-to-analog converters for the entire detector module or pixel-by-pixel within given limits or ranges. The counter contents of the pixel elements are successively read out module-by-module by a corresponding readout unit. This reading process involves a certain amount of time, during which counting cannot continue without errors.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the present embodiments provide a method for acquiring (e.g., taking) an X-ray image in which the quality of X-ray imaging is improved via counting X-ray detectors. Also disclosed is an X-ray system (e.g., machine) suitable for implementing the method.

The method for acquiring an X-ray image of an examination subject uses a counting digital X-ray detector of an X-ray system, e.g., for dual- or multi-energy imaging. The X-ray detector has an X-ray converter for direct or indirect conversion of X-ray radiation into an electrical signal and a matrix having a plurality of counting pixel elements. At least one variable threshold value is applied for each pixel element such that an incoming signal is counted by a memory unit (e.g., counter) in each instance that the incoming signal exceeds the at least one variable threshold value. The method includes receiving a request to acquire (e.g., take) one or more X-ray images, automatically determining two or more threshold values, the threshold values being individually adjusted to the respective acquisition of the X-ray images(s), setting the determined threshold values in the X-ray detector, applying X-ray radiation while the determined threshold values are applied, converting X-ray quanta into count signal, storing the count signals in the X-ray detector, outputting (e.g., reading out) image data representing the X-ray image from the X-ray detector, and displaying or storing the X-ray image.

For each newly planned X-ray shot, one or more individual threshold values are determined for the pixel elements. The threshold values may be selected or adjusted to the radiographic situation and conditions, so that improved X-ray imaging with higher image quality may be achieved. The selection or adjustment also enables the X-ray dose to be better utilized, which allows the X-ray dose to be reduced, thereby exposing the patient and doctor to a lower radiation load. In addition, various special applications, such as K-edge imaging, that are only possible to a limited extent under standard conditions, may be implemented with good X-ray quality. Via a single X-ray detector, different types of shots may be implemented in quick succession with high image quality using, e.g., different X-ray spectra. For example, the same threshold value(s) may be determined for all of the pixel elements. Alternatively, individual threshold values may be determined, respectively, for each pixel element.

At least two different, variable threshold values may be applied simultaneously for each pixel element. The at least two threshold values are automatically determined. The at least two threshold values are individually adjusted to the respective acquisition of the X-ray images or images. Individual determination of the threshold values is useful for at least two different threshold values, e.g., energy discrimination, because quality differences and losses may occur without such adjustment.

In one embodiment, X-ray system information, such as the type of X-ray imaging, the characteristics of the X-ray detector, the characteristics of the X-ray spectrum of the X-ray radiation, the characteristics of the examination subject, or a combination thereof, is ascertained and used for determining the threshold values. The information may change the constraints for the threshold values, so it is useful to consider the information for respective determination of the threshold values. The type of X-ray imaging may mean, for example, information indicative of whether a single-, dual- or multi-energy image is to be acquired. The X-ray spectrum may be affected, for example, by the tube voltage or the filtering. The characteristics of the examination subject may also vary markedly. For each variable, a different setting of the threshold values may be useful for the X-ray imaging quality.

The X-ray system information includes the tube current of an X-ray tube, the tube voltage of the X-ray tube, a degree of X-ray beam hardening, an angulation or geometry of an imaging system, a filtering of the X-ray radiation, a water equivalent of the examination subject, a material characteristic (e.g., the K-edge) of the X-ray converter, a material characteristic (e.g., the K-edge) of the examination subject, or a combination thereof.

The information is requested by a control device or from a memory unit of the X-ray system to which the X-ray detector is assigned. The information request may be implemented automatically as soon as a new X-ray shot is requested.

According to one embodiment, the information is used to predefine one or more constraints for determining the threshold values, so that adjustment of the threshold values may be implemented automatically via the constraints. The threshold values are calculated or estimated based on the constraints. Constraints are designed to limit the selection of possible threshold values or to select threshold values directly. For example, a constraint may provide that the threshold values only assume a value in a specific value range. One threshold value or a small number of possible threshold values may be determined directly if, for example, more than one or a plurality of further constraints are provided. A predefined constraint may also provide that equidistant spacings exist between a plurality of threshold values to be determined (e.g., in the case of multi-energy imaging).

According to one embodiment, predefined or preset constraints are additionally used to determine the threshold values. The constraints may be provided, for example, to exclude respective very high or very low value ranges.

According to one embodiment, inputs are additionally accepted. The inputs are used to define further constraints. For example, information sources external to the X-ray system or user queries and inputs may be provided. Thus, equipment operators may provide inputs to exclude threshold values or define value ranges.

Good image quality is achieved via determination and setting of new calibration data of the X-ray detector prior to application of the X-ray radiation.

According to one embodiment, the image data representing the X-ray image undergoes image processing and/or image correction. Such image processing or correction serves to further optimize the display of the X-ray images, e.g., by removing noise or artifacts from the image data, so that a doctor may easily obtain relevant information from the X-ray images for diagnosis or treatment.

An X-ray system for dual- or multi-energy imaging is provided to implement the method. The X-ray system has a counting digital X-ray detector, which has an X-ray converter for directly or indirectly converting X-ray radiation into an electrical signal and a matrix having a plurality of counting pixel elements. For each pixel element, at least one or simultaneously at least two different threshold values may be applied such that an incoming signal is counted by a memory unit (e.g., a counter) in each instance that the incoming signal exceeds the at least one or two threshold values. The X-ray system also includes an X-ray tube for emitting X-ray radiation to irradiate an examination subject, a system controller to control the X-ray system, a processing unit to determine the individual threshold values, and an imaging system to process and display X-ray images.

### BRIEF DESCRIPTION OF THE DRAWINGS

FIG. 1 shows a view of a known X-ray system for use in interventional procedures.

FIG. 2 shows a view of a known X-ray detector having a scintillator.

FIG. 3 shows a section through part of a known X-ray detector having a plurality of detector modules.

FIG. 4 shows a perspective, plan view of a cross-section of a known X-ray detector having a plurality of detector modules.

FIG. 5 shows a representation of central functional elements of a counting pixel element of a known X-ray detector.

FIG. 6 shows a representation of a matrix of counting pixel elements of a known X-ray detector having control and readout logic.

FIG. 7 shows a representation of the central functional elements of a counting, energy-discriminating pixel element of an X-ray detector according to one embodiment.

FIG. 8 shows an example of a first X-ray spectrum compared to three fixed threshold values.

FIG. 9 shows an example of a second X-ray spectrum compared to the same three threshold values in the comparison of FIG. 8.

FIG. 10 shows a flow chart of a method according to one embodiment.

FIG. 11 shows another flow chart of a method according to one embodiment.

### DETAILED DESCRIPTION

FIG. 8 and FIG. 9 show two different X-ray spectra typical for X-ray imaging, both prior to and after irradiation of an examination subject. A first X-ray spectrum R1 has a higher maximum X-ray energy than a second X-ray spectrum R2, resulting, e.g., from a higher tube voltage of the X-ray tube used. In addition, the X-ray spectra are also shown after two different hardenings a and b at the detector input. Depending on the tube voltage, and pre-filtering of the X-ray radiation and filtering by examination subject and possibly other objects, such as the patient table, the X-ray spectrum is hardened to a lesser or greater degree. FIG. 8 shows a first input X-ray spectrum R1a hardened to a degree a and a first input X-ray spectrum R1b hardened to a degree b. FIG. 9 shows a second input X-ray spectrum R2a hardened to a degree a and a second input X-ray spectrum R2b hardened to a degree b. For many X-ray spectra, image quality may be adversely affected if an X-ray detector has, e.g., three different threshold values for energy resolution (e.g., setting the same three threshold values, a first fixed threshold value SW1, a second fixed threshold value SW2 and a third fixed threshold value SW3). The image to be achieved may be falsified. While, for a few X-ray spectra, good X-ray image quality is achieved.

Different X-ray spectra do not mean a difference arising from varying absorption and therefore the number of transmitted X-ray quanta and the spectral distribution thereof from location to location (e.g., by the organs of the examination subject or interventional tools, such as catheters, stents). Different X-ray spectra instead means a fundamental (average) change in the X-ray spectrum due to, e.g., use of different generator voltages, the extent to which the patient is fatter or thinner, whether differential pre-filtering is performed, or whether radiation penetrates more or less tissue of the examination subject through more or less steep angulations in total.

The threshold values are appropriately defined depending on the radiological conditions prior to acquiring a new X-ray shot in order to thus enable optimum imaging for the desired application and radiological conditions. FIG. 10 shows a flow chart of an automatic method to this end. FIG. 11 shows another, more detailed method according to one embodiment. The method may be implemented at least partly by a processing unit, e.g., a PC having corresponding software. The PC may be connected to a control unit (e.g., a system controller) of the X-ray system to which the X-ray detector is assigned. The control unit may control, e.g., the remaining acts. The X-ray detector is a counting X-ray detector as shown, e.g., in FIGS. 3 and 4. In each case, the counting X-ray detector has a plurality of pixel elements as shown, e.g., in FIG. 7. At least one or simultaneously at least two different variable threshold values may be applied to each pixel element. An incoming signal is counted by a memory unit, e.g., a counter, in each instance that the incoming signal is above, or exceeds, the at least one or two threshold values. The X-ray system also has an X-ray tube for emitting X-ray radiation to irradiate the examination subject, a system controller for controlling the X-ray system, and an imaging system for processing and displaying X-ray images.

In a first act S1, a request to acquire one or more X-ray images(s) or rather a sequence of X-ray images is received. A request may be entered by an equipment user or launched automatically (e.g., programmatically). In a second act S2, one or more individual threshold values are determined for the new shot to be created, e.g., by calculating, estimating or otherwise defining threshold values based on information relating to the radiological conditions or the X-ray system, or based on constraints, or a combination of such information and constraints. To determine, calculate or select individual threshold values, a wide variety of information regarding the planned shot or the X-ray system may be used. FIG. 11 shows that such information may be requested by the X-ray system, e.g., by a request act AF. For example, the processing unit implementing the act may request information via a communicative connection with the system controller of the X-ray system or retrieve the information from a memory unit. From the information, various constraints may be created and used. The constraints are then used for determining the threshold values. FIG. 11 shows different groups of constraints, which may be used, or which may be obtained from the corresponding information. Other constraints may be used.

The information is, for example, information concerning the imaging modality or the application (e.g., single-, dual- or multi-energy imaging, K-edge imaging, single shots or shot sequences, DSA (digital subtraction angiography), cardioangiography, fluoroscopy, or high-contrast or low-contrast imaging). In addition, information about the X-ray spectrum, the energy range, the filtering, and the examination subject may be used. Further information is detector-related information, e.g., the size and number of pixel elements, or the positions of the pixel elements. Further information affecting X-ray imaging may also be jointly used to determine the threshold values. As shown in FIG. 11, the information may first be used to define constraints for determining, calculating or estimating the threshold values. Three categories of constraints which may be used to determine the threshold values are shown in the example of FIG. 11 in accordance with the information from which the constraints are established. The categories include application-related constraints RB1, X-ray spectrum and patient-related constraints RB 2 and detector-related constraints RB3. Overlaps may be used. Examples of using information to predefine constraints are described further below.

In a third act S3, the threshold value(s) are applied to the pixel elements so that signals that lie below the threshold value are not counted and the signals above the threshold value may be counted. Alternatively, the threshold value(s) are applied so that classifications into different levels may occur in connection with a plurality of threshold values and energy discrimination. A precise procedure for applying threshold values for pixel elements is known from the prior art. For example, a voltage is generated via, e.g., a DAC. The voltage is compared with the voltage of the signal generated at the output of the amplifier. If the signal voltage is the same as or higher than the voltage set by the DAC, the corresponding counter is incremented by one, otherwise not. When the threshold values are applied, in a fourth act S6, an X-ray acquisition (or also a plurality or sequence of X-ray acquisitions) is implemented, in which an examination subject is irradiated by X-ray radiation from an X-ray source and the resulting attenuated radiation is detected by the X-ray detector. In detecting the X-ray radiation with an X-ray detector having, for example, a direct converter, X-ray quanta are converted into electrical signals and the electrical signals are then converted by the pixel elements of the active matrix of the X-ray detector into count signals in a positionally dependent manner and as a function of their signal level and stored. Indirectly converting X-ray detectors may also be used. In a fifth act S7, the count signals are read from the pixel elements via peripheral electronics and in a sixth act S10 are either stored in memory units or displayed as X-ray images on display units. Output (e.g., readout) of the count signals representing image data and the storage or display (or both) of the image data as X-ray images may be in accordance with procedures for known counting X-ray detectors.

The method may be useful in numerous ways, including comprehensive improvement and optimization of image quality in individual cases and in all applications and uses of the X-ray detector and of the X-ray system in which the X-ray detector is incorporated. Further, the dose efficiency may be adjusted and optimized.

A number of examples of how information may be used to create constraints are provided below.

Given information that the X-ray detector does not include or use a coincidence circuit for imaging, it follows that k-escape photons are suppressed, resulting in a constraint that the lowest threshold value is above the so-called k-escape of the X-ray converter. Given information that a coincidence circuit is present or being used, an entrainment of k-escape photons (e.g., useful if a coincidence and summation device of adjacent pixel elements is present) may be inferred, resulting in constraints that the lowest threshold value is below the k-escape of the X-ray converter. If, for the planned X-ray shot, counter events having a signal above the anticipated maximum energy are to be suppressed, the highest threshold value in the maximum energy range of the X-ray spectrum is established as a constraint. In the case of planned K-edge imaging, an arrangement of the threshold value(s) around the corresponding K-edge is selected as a constraint, e.g., a threshold value above and a threshold value below. In the case of planned dual- or multi-energy imaging, a number of threshold values corresponding to the imaging are selected as a constraint.

In angiography, the tube voltage, for example, is often not fixed, but arises, e.g., based on the calculated water equivalent, which, in turn, depends on the examination subject and angulation of the imaging system (of the X-ray system), as well as on the maximum tube current, pre-filtering and other variables. A maximum X-ray quantum energy is defined accordingly. As a constraint, the highest threshold value may be correspondingly matched to the maximum tube voltage defined for the specific projection and examination.

The X-ray spectrum at the input of the X-ray detector may be estimated, for example, by the tube voltage, pre-filtering, the geometry or the water equivalent of the examination subject (patient equivalent), and the position of the highest threshold value selected accordingly. For the lowest threshold value, a noise threshold of the X-ray detector may be selected as the position. One constraint may be that the different threshold values are equidistant.

A number of examples for determining specific threshold values are described below in an embodiment in which a pixel design has three different threshold values for each pixel element.

(Example 1) A first threshold value is fixed just above the noise threshold and also above a known k-escape energy of Cd or Te, as the case may be (approximately 23 and 27 keV respectively). The other threshold values two and three then have the constraints of being above the first threshold value but below the anticipated maximum energy resulting from the tube voltage. At the same time, all three threshold values are equally spaced. (Example 2) A first threshold value has the constraint of being disposed above the noise threshold but below the k-escape energy of Cd or Te, as the case may be. A third threshold value is just above the anticipated maximum energy in view of the generator voltage, and a second threshold value has the constraint of being disposed equidistantly between the first and second threshold values. (Example 3) A first threshold value has the constraint of being disposed above the noise threshold but below the k-escape energy of Cd or Te, as the case may be. A second threshold value is below the K-edge of iodine, and a third threshold value is above the K-edge of iodine. (Example 4) All three threshold values have the constraints of being spaced equidistantly with respect to one another.

In addition to determining threshold values and their settings, in a seventh act S4 (FIG. 11), each time new threshold values are determined, relevant calibration data may also be re-determined for, e.g., data correction. The calibration data is then used in an eighth act S5 for updating the previously set calibration data. Prior to or during display of the acquired image data, live image processing methods are implemented in a ninth act S8. Alternatively or additionally, offline image processing methods are implemented in a tenth act S9 for, e.g., correction (noise correction, gain correction, etc.) or improvement of image quality.

An X-ray system is designed for, e.g., dual- or multi-energy imaging and has a counting digital X-ray detector having an X-ray converter for directly or indirectly converting X-ray radiation into an electrical signal and a matrix having a plurality of counting pixel elements. One or simultaneously at least two different, variable threshold values may be applied for each pixel element such that an incoming signal is counted using a memory unit (e.g., a counter) in each instance that the incoming signal is above the one or at least two threshold values. The threshold values may be applied by, e.g., discriminators and DACs. The X-ray system also has an X-ray tube for emitting X-ray radiation to irradiate the examination subject, a system controller for controlling the X-ray system, a processing unit for determining the individual threshold values, and an imaging system for processing and displaying X-ray images. The method may be implemented automatically by the X-ray system. The pixel elements may also be connected, for example, to immediately adjacent pixel elements such that the distribution of the signal over more than one pixel element is compensated, e.g. by K-escape or “charge sharing” using coincidence circuits, and the signal is brought together by summation. This connection provides (e.g., ensures) that multiple counts and incorrect energy assignments are prevented.

In angiography, very different rms pixel sizes are used in some cases. For this purpose, so-called pixel binning is employed. More or less adjacent pixel elements are combined, either in an analog manner in the X-ray detector or digitally at some point in image processing. Analog-digital binning (e.g., binning partly in the analog path and partly in the digital path) is possible. For example, if an X-ray detector used for angiography has a pixel size of 180×180 m², different binning may be used for different applications, such as 1×1 binning (180 m) for DSA (digital subtraction angiography), cardioangiography and fluoroscopy in the higher zoom mode, 2×2 binning (360 m) for fluoroscopy in overview format or low zoom level and 3D imaging (e.g. rotational angiography, high contrast), as well as 3×3 or 4×4 binning (540 m, 720 m) for 3D imaging (low contrast).

For counting and in particular counting and energy-discriminating X-ray detectors, the rms pixel size has a significant effect on the relative number of X-ray quanta absorbed in the converter layer. The signals of the X-ray quanta are distributed over a plurality of adjacent (rms) pixel elements by K-escape or charge sharing. As these effects are likely to occur during absorption of the X-ray quantum at the pixel edge, the relative frequency of these events is reduced as the rms pixel size increases.

For a counting X-ray detector having next-neighbor coincidence and signal summation capability, 1×1 binning capability may be incorporated into or used in the ASIC design. In the case of 2×2 or higher binning, on the other hand, this possibility may be dispensed with in some circumstances. The use or non-use of a next-neighbor coincidence circuit and/or signal summation is an additional item of information that may be used to determine the individual threshold values in order to achieve a positive effect on the quality of the X-ray imaging.

A counting, energy-selective X-ray detector has a plurality of variable threshold values for each pixel element. Individual threshold values may be determined, estimated or calculated for the X-ray detector in accordance with information or constraints (or both). Examples of the information and constraints are as follows:

information regarding the field of the application, such as non-energy-resolved imaging with maximization of the detective quantum efficiency (DQE), energy discriminating or material-sensitive imaging (e.g. dual- or multi-energy, K-edge imaging, etc.);

information indicative of specific uses, such as fluoroscopy, DSA, cardioangiography, and 3D;

information in the area of detector characteristics, such as use of coincidence circuit or signal summation, the number of threshold values or detector binning (e.g., 1×1 or 2×2);

constraints, such as the thickness of the examination subject in the projection direction;

constraints, such as the angulation used or the shape (e.g., the end point);

constraints determined by the generator setting, such as maximum anticipated keV of the X-ray spectrum at the X-ray detector input, the maximum kV and, therefore, the maximum keV. The shape may be calculated or estimated by, e.g., an average anticipated hardening due to pre-filtering and a patient model.

In summary, to improve the quality of X-ray imaging, a method is provided for acquiring an X-ray image of an examination subject via a counting digital X-ray detector of an X-ray system configured for, e.g., dual- or multi-energy imaging. The X-ray detector has an X-ray converter for directly or indirectly converting X-ray radiation into an electrical signal, and a matrix having a plurality of counting pixel elements. At least one variable threshold value may be applied to each pixel element such that an incoming signal is counted by a memory unit (e.g., a counter) in each instance that the incoming signal is above the at least one variable threshold value. The method includes receiving a request to acquire one or more X-ray images, automatically determining one or more threshold values individually adjusted to the respective taking of the X-ray image(s), setting the previously determined threshold value(s) in the X-ray detector, applying X-ray radiation during while the threshold value(s) are applied, converting X-ray quanta into count signals, storing the count signals in the X-ray detector, outputting of image data representing the X-ray image from the X-ray detector, and displaying or storing the X-ray image.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for acquiring an X-ray image of an examination subject via a counting digital X-ray detector of an X-ray system, wherein the X-ray detector comprises an X-ray converter for directly or indirectly converting X-ray radiation into an electrical signal and a matrix having a plurality of counting pixel elements, wherein at least one variable threshold value is applied for each pixel element of the plurality of counting pixel elements such that an incoming signal is counted by a memory unit in each instance that the incoming signal is above the at least one variable threshold value, the method comprising:
receiving a request for acquisition of one or more X-ray images;
determining automatically one or more threshold values, wherein determining comprises individually adjusting the one or more threshold values in accordance with the acquisition of the one or more X-ray images;
setting the one or more determined threshold values in the X-ray detector;
applying X-ray radiation while the one or more determined threshold values are applied;
converting X-ray quanta into count signals;
storing the count signals in the X-ray detector;
outputting image data representative of the one or more X-ray images from the X-ray detector; and
displaying or storing the one or more X-ray images.

2. The method of claim 1, further comprising:
applying, for each pixel element, at least two different, variable threshold values simultaneously; and
individually adjusting the at least two different, variable threshold values in accordance with the acquisition of the one or more X-ray images.

3. The method of claim 1, wherein determining the one or more threshold values comprises:
obtaining information about the X-ray system; and
using the information to determine the one or more threshold values.

4. The method of claim 3, wherein obtaining the information comprises requesting, with a control device, the information.

5. The method of claim 3, further comprising using the information to predefine one or more constraints for determining the one or more threshold values.

6. The method of claim 1, wherein determining the one or more threshold values comprises using predefined constraints to determine the one or more threshold values.

7. The method of claim 1, further comprising:
accepting inputs; and
using the inputs to define constraints;
wherein determining the one or more threshold values comprises using the constraints to determine the one or more threshold values.

8. The method of claim 1, wherein determining the one or more threshold values comprises calculating the one or more threshold values based on one or more constraints.

9. The method of claim 3, wherein the information is indicative of a tube current of an X-ray tube, a tube voltage of the X-ray tube, a degree of hardening of the X-ray radiation, angulation or geometry of an imaging system, filtering of the X-ray radiation, a water equivalent of the examination subject, a material characteristic of an X-ray converter, a material characteristic of the examination subject, or a combination thereof.

10. The method of claim 6, wherein the predefined constraint includes equidistant spacings between a plurality of threshold values.

11. The method of claim 1, further comprising determining X-ray detector calibration data prior to application of the X-ray radiation.

12. The method of claim 1, further comprising processing the image data representative of the one or more X-ray images to implement image processing, image correction, or a combination thereof.

13. An X-ray system for dual- or multi-energy imaging, the X-ray system comprising:
a counting digital X-ray detector comprising an X-ray converter for directly or indirectly converting X-ray radiation into an electrical signal and further comprising a matrix having a plurality of counting pixel elements, wherein at least one variable threshold value is applied for each pixel element of the plurality of counting pixel elements such that an incoming signal is counted by a memory unit in each instance the incoming signal is above the at least one variable threshold value;
an X-ray tube to emit X-ray radiation to irradiate an examination subject;
a system controller to control the X-ray system;
a processing unit to determine the at least one variable threshold value, the processing unit being configured to individually adjust the at least one variable threshold value; and
an imaging system for processing and displaying X-ray images.

14. The X-Ray system of claim 13, wherein the memory unit comprises a counter.

15. The X-Ray system of claim 13, wherein the counting digital X-ray detector is configured such that the incoming signal is counted when simultaneously above at least two different variable threshold values.

16. The X-Ray system of claim 13, wherein the processor is configured to obtain and use information about the X-Ray system to determine the threshold value.

17. The method of claim 3, wherein the information about the X-ray system comprises a type of X-ray imaging, characteristics of the X-ray detector, characteristics of an X-ray spectrum of the X-ray radiation, characteristics of the examination subject, or combinations thereof.

18. The method of claim 3, wherein obtaining the information comprises retrieving the information from a memory unit of the X-ray system.

19. The method of claim 5, wherein using the information comprises estimating the one or more threshold values based on the one or more constraints.

20. The method of claim 9, wherein the material characteristic of the X-ray converter or the examination subject is K-edge.
